(19) United States
(12) Patent Application Publication
(10) Pub. No.: US 2016/0311123 A1
(43) Pub. Date: Oct. 27, 2016

(54) TOOL WORN ON USER'S HAND

(71) Applicant: Jess Michael Schoon, Fergus Falls, MN (US)

(72) Inventor: Jess Michael Schoon, Fergus Falls, MN (US)

(21) Appl. No.: 15/136,595

(22) Filed: Apr. 22, 2016

Related U.S. Application Data
(60) Provisional application No. 62/151,454, filed on Apr. 23, 2015.

(51) Int. Cl. B26B 27/00; B26B 5/00; B26B 29/02

(52) U.S. Cl. CPC B26B 27/007; B26B 29/02; B26B 5/00

(57) ABSTRACT

Aspects of the present disclosure are directed toward apparatuses, systems, and methods that include a blade having at least one sharp edge; a housing that releasably houses and positions the blade, and a moveable guard assembly configured to cover the at least one sharp edge.

### TECHNICAL FIELD

Embodiments of the present disclosure relate to apparatuses, systems, and methods that are directed toward a tool that includes a blade. More specifically, embodiments of the disclosure relate to devices and methods including a tool to be worn on a user's hand that deploys or allows access to a blade when desired.

### BACKGROUND

Utility knifes and other similar devices require a user to hold the knife/device in the palm of their hand. These utility knives may be misplaced after a user sets the knife down. In certain instances, the user may need to bend their wrist in an un-natural position to use it, which can stress the user's hand and wrist. In other instances, a user having a disability may have difficultly manipulating a common utility. Thus, common utility knives may be difficult for use in a number of different circumstances.

### SUMMARY

In Example 1, an apparatus comprising: a blade having at least one sharp edge; a housing a distal end including an opening and a proximal end, the housing configured to releasably house the blade and position the blade through the opening; a moveable guard assembly configured to cover the at least one sharp edge in a first configuration and expose the at least one sharp edge in a second configuration; and a grip component arranged with the moveable guard assembly and configured to transition the moveable guard assembly between the first configuration and the second configuration.

In Example 2, the apparatus of Example 1, wherein the moveable guard assembly is configured to automatically transition between the second configuration and the first configuration in the absence of a force applied by a user.

In Example 3, the apparatus of Example 2, further comprising a spring arranged within the housing, the spring being configured to interface with the moveable guard assembly to automatically transition between the second configuration and the first configuration in the absence of a force applied by the user

In Example 4, the apparatus of Example 1, wherein the housing comprises a longitudinal axis and a lateral axis, and a lower surface of the housing extending along the longitudinal axis is configured to contact at least a portion of an upper surface of a user's hand.

In Example 5, the apparatus of Example 4, further comprising an elastic strap arranged near the proximal end of the housing, the elastic strap being configured to position and maintain the housing along the upper surface of the user's hand.

In Example 6, the apparatus of Example 4, wherein the moveable guard assembly comprises a first width aligned with the lateral axis of the housing and the grip component comprises a second width aligned with the lateral axis of the housing, and the second width is greater than the first width.

In Example 7, the apparatus of Example 6, wherein the grip component comprises a substantially cylindrical shape.

In Example 8, the apparatus of Example 1, wherein the housing comprises an internal section and an external section, the internal section comprises first surface and a second surface, the second surface being recessed relative to the first surface and configured to hold the blade within the housing.

In Example 9, the apparatus of Example 8, further comprising blade locking cogs arranged within the recessed surface and configured to engage the blade and maintain the position of the blade within the housing during use.

In Example 10, the apparatus of Example 9, further comprising a magnet arranged within the recessed surface and configured to engage the blade and maintain the position of the blade within the housing during use.

In Example 11, the apparatus of Example 9, wherein the internal section comprises a third surface and a fourth surface, and the third surface and the fourth surface are arranged opposite the first surface and the second surface.

In Example 12, the apparatus of Example 11, wherein the fourth surface protrudes outwardly from the third surface toward the recessed surface, and the fourth surface is configured to force the blade within the recessed surface.

In Example 13, an apparatus for a user's hand, the apparatus comprising: a blade having at least one sharp edge; a housing including a proximal end, a distal end an opening arranged near the proximal end, and a lower surface configured to contact at least a portion of an upper surface of the user's hand, the housing being configured to releasably house the blade and position the blade through the opening; a moveable guard assembly configured to cover the at least one sharp edge in a first configuration and expose the at least one sharp edge in a second configuration; a grip component arranged with the moveable guard assembly and configured to transition the moveable guard assembly between the first configuration and the second configuration in response to the user applying a force; and an elastic strap arranged near the proximal end of the housing, the elastic strap being configured to position and maintain the housing along the upper surface of the user's hand.

In Example 14, the apparatus of Example 13, wherein the elastic strap is configured to wrap around the user's wrist to position and maintain the housing along the upper surface of the user's hand.

In Example 15, the apparatus of Example 13, wherein the moveable guard assembly is configured to automatically transition between the second configuration and the first configuration in the absence of the force applied by a user.

In Example 16, the apparatus of Example 13, wherein the moveable guard assembly comprises an upper surface facing the housing and sidewalls surrounding the upper surface, and the upper surface and the sidewalls of the moveable guard assembly are configured cover the blade in the first configuration.

In Example 17, a method of using a tool worn on a user's hand, the method comprising: arranging a tool along an upper surface of the user's hand, the tool including a blade having at least one sharp edge, a housing including a proximal end, a distal end an opening arranged near the proximal end and being configured to releasably house the blade and position the blade through the opening, a moveable guard assembly configured to cover the at least one sharp edge, and a grip component arranged with the moveable guard assembly; gripping a portion of the grip component; and applying a force to the grip component to actuate the moveable guard in a first configuration away from the housing to expose the at least one sharp edge in a second configuration.

In Example 18, the method of Example 17, further comprising releasing the grip component to actuate the moveable guard from the second configuration to the first configuration.

In Example 19, the method of Example 18, wherein releasing the grip component includes covering the at least one sharp edge with the moveable guard assembly.

In Example 20, the method of Example 17, wherein arranging the tool along the upper surface of the user's hand comprising arranging an elastic strap, coupled to the housing, around the user's wrist to position and maintain the housing along the upper surface of the user's hand.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1A is a side view illustration of an example utility apparatus including a moveable guard assembly in an open configuration, in accordance with embodiments of the disclosure.

FIG. 1B is a side view illustration of the example utility apparatus, as shown in FIG. 1A, with the moveable guard assembly in a closed configuration, in accordance with embodiments of the disclosure.

FIG. 2A is an illustration of another example utility apparatus, in accordance with embodiments of the disclosure.

FIG. 2B is an illustration of the example utility apparatus, shown in FIG. 2A, including a stabilizing rod, in accordance with embodiments of the disclosure.

FIG. 3A is an isometric view illustration of a first component that may be form a portion of an example utility apparatus housing, in accordance with embodiments of the disclosure.

FIG. 3B is a side view illustration of the first component, shown in FIG. 3A, in accordance with embodiments of the disclosure.

FIG. 3C is an end view illustration of the portion of the first component, shown in FIGS. 3A-B, in accordance with embodiments of the disclosure.

FIG. 4A is an isometric view illustration of a second component that may be form a portion of an example utility apparatus housing, in accordance with embodiments of the disclosure.

FIG. 4B is an end view illustration of the second component, shown in FIG. 4A, in accordance with embodiments of the disclosure.

FIG. 5 is an isometric view illustration of a grip component portion and a moveable guard assembly that may be included with utility apparatuses, in accordance with embodiments of the disclosure.

While the disclosure is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

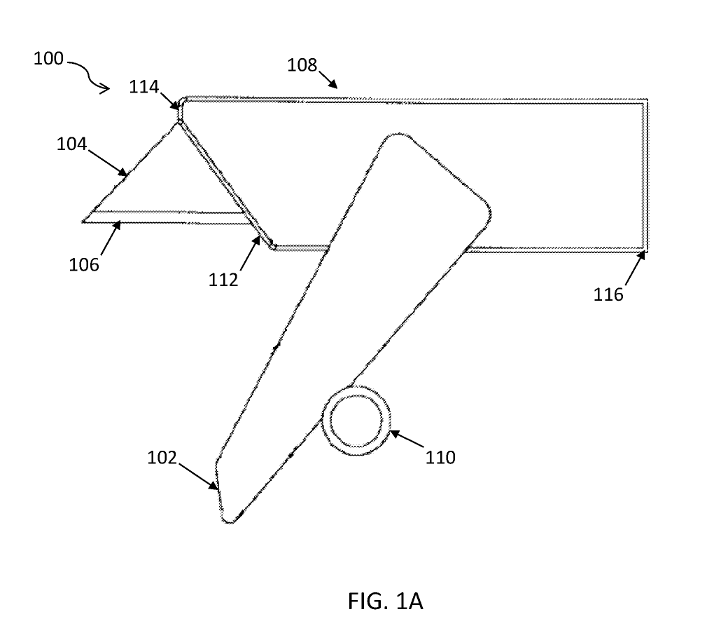

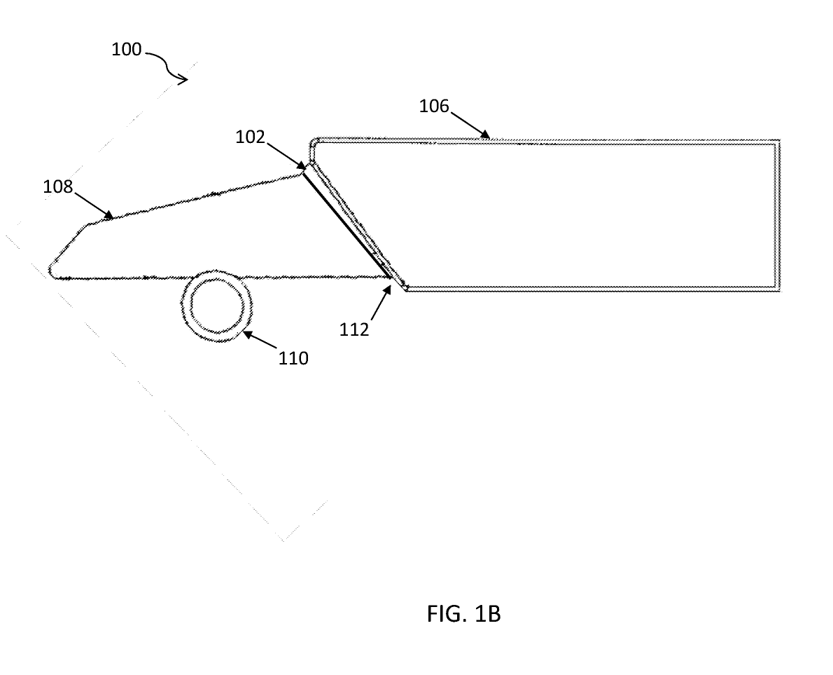

FIG. 1A is a side view illustration of an example utility apparatus 100 including a moveable guard assembly 102 in an open configuration, in accordance with embodiments of the disclosure. In addition to the moveable guard assembly 102, the utility apparatus 100 may also include a blade 104, a housing 108, and a grip component 110. The housing 108 may provide surfaces to allow a user to manipulate the utility apparatus 100. The housing 108 may include an opening 112 through which the blade 104 may extend. As shown in FIG. 1A, the blade 104 extends through the opening 112 in the housing 108 at a proximal end 114. In certain instances, a distal end 116 of the housing 108 may be a surface to manipulate and force the blade 104 into an object or surface. In addition, the blade 104 may have at least one sharp edge 106.

The moveable guard assembly 102 is shown in FIG. 1A in an open configuration. In the open configuration shown in FIG. 1A, the moveable guard assembly 102 is configured to expose the at least one sharp edge 106. As shown and discussed in further detail with reference to FIG. 1B, the moveable guard assembly 102 may be configured to cover the at least one sharp edge 106.

The utility apparatus 100 may also include a grip component 110. The grip component 110 may be arranged with the moveable guard assembly 102 and configured to transition the moveable guard assembly 102. The grip component 110 may allow a user of the utility apparatus 100 to grip and manipulate the moveable guard assembly 102. The grip component 110 may have a greater width than the moveable guard assembly 102 to provide gripping surfaces on either side of the moveable guard assembly 102.

FIG. 1B is a side view illustration of the utility apparatus 100, as shown in FIG. 1A, with the moveable guard assembly 102 in a closed configuration, in accordance with embodiments of the disclosure. In certain instances, the moveable guard assembly 102 may protect a user against accidental cutting of an object or the user itself. For example, the moveable guard assembly 102 may be actuated by the user between the open and closed configurations.

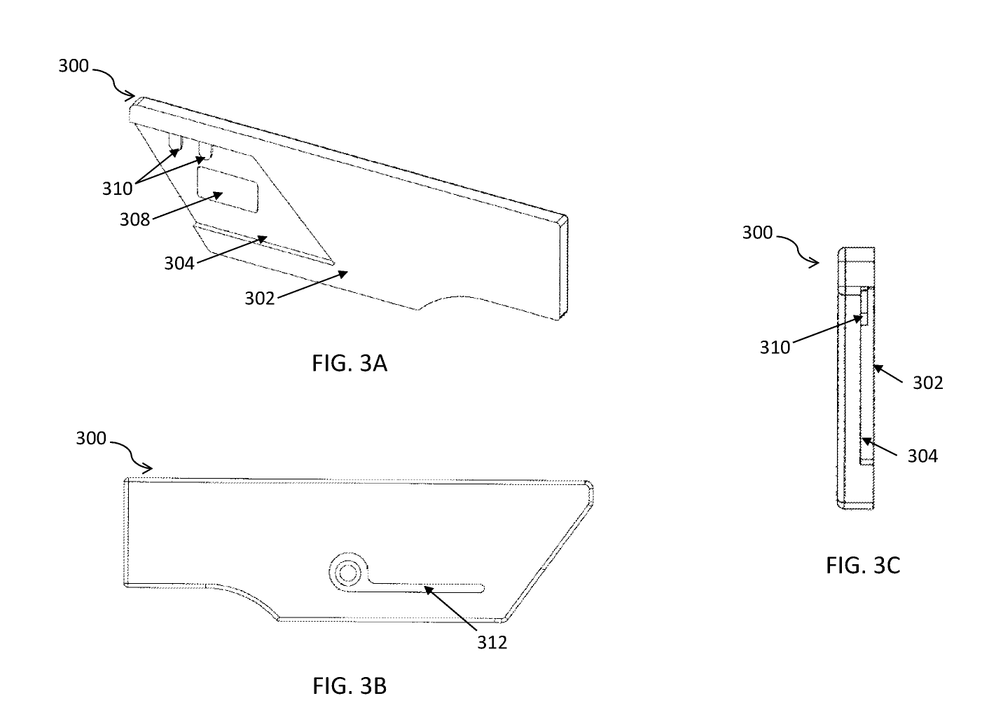

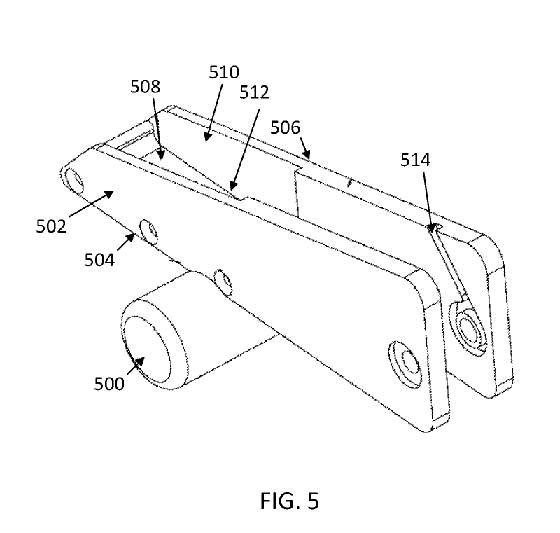

In certain instances, the closed configuration shown in FIG. 1B may be considered a first configuration and the open configuration shown in FIG. 1A may be considered a second configuration. The moveable guard assembly 102, in certain instances, may automatically transition from the open (second) configuration to the closed (first) configuration. The automatic transition of the moveable guard assembly 102 between the second configuration and the first configuration may occur in the absence of a force applied by a user. More specifically, the moveable guard assembly 102 and a portion of the housing 108 may include a spring (or similar structure) that is biased to force the moveable guard assembly 102 in the closed (second configuration). Thus, the moveable guard assembly 102 may be configured to cover the at least one sharp 106 edge in a first configuration (the closed configuration shown in FIG. 1B) and expose the at least one sharp edge 106 in a second configuration (the open configuration shown in FIG. 1A. As noted above, the grip component 110 is arranged with the moveable guard assembly 102 and configured to transition the moveable guard assembly 102 between the first configuration and the second configuration. The spring (not shown) and other aspects are discussed in further detail with reference to, for example, FIG. 3B and FIG. 5.

The combination of the moveable guard assembly 102 and the housing 108 allow the blade 104 to be self-stowing, which may improve safety of in using the utility apparatus 100 as compared to convention utility knives. The utility apparatus 100 may reduce workplace injuries from accidental cutting and unintended use.

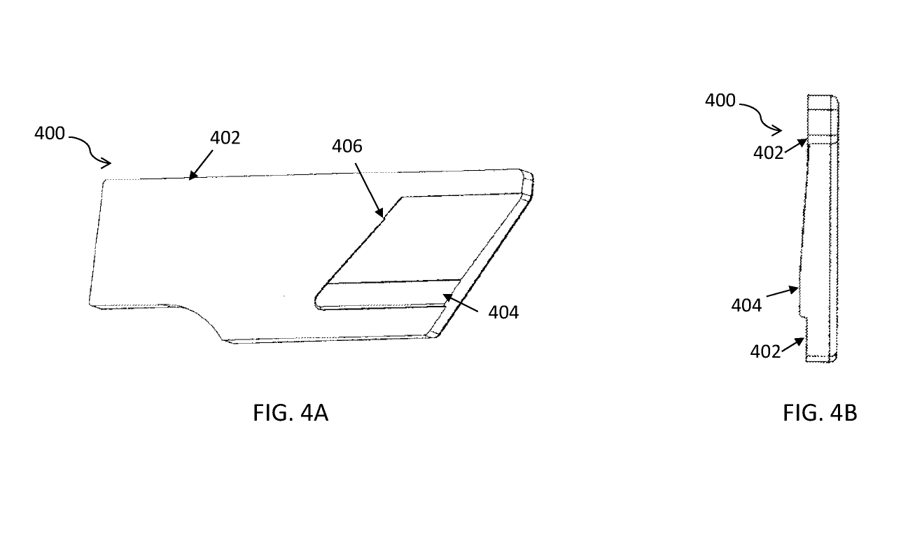

The utility apparatus 100 shown in FIGS. 1A-B is not intended to suggest any limitation as to the scope of use or functionality of embodiments of the subject matter disclosed throughout this disclosure. Neither should the utility apparatus 100 be interpreted as having any dependency or requirement related to any single component or combination of components illustrated in FIG. 1. For example, in embodiments, the utility apparatus 100 may include additional components. For example, the housing 108 may be formed by a first component 300 and a second component 400, as discussed in further detail below with reference respectively to FIGS. 3A-C and FIGS. 4A-B. Additionally, any one or more of the components depicted in FIGS. 1A-B can be, in embodiments, integrated with various ones of the other components depicted therein (and/or components not illustrated). Any number of other components or combinations of components can be integrated with the illustrative utility apparatus 100 depicted in FIGS. 1A-B, all of which are considered to be within the ambit of this disclosure.

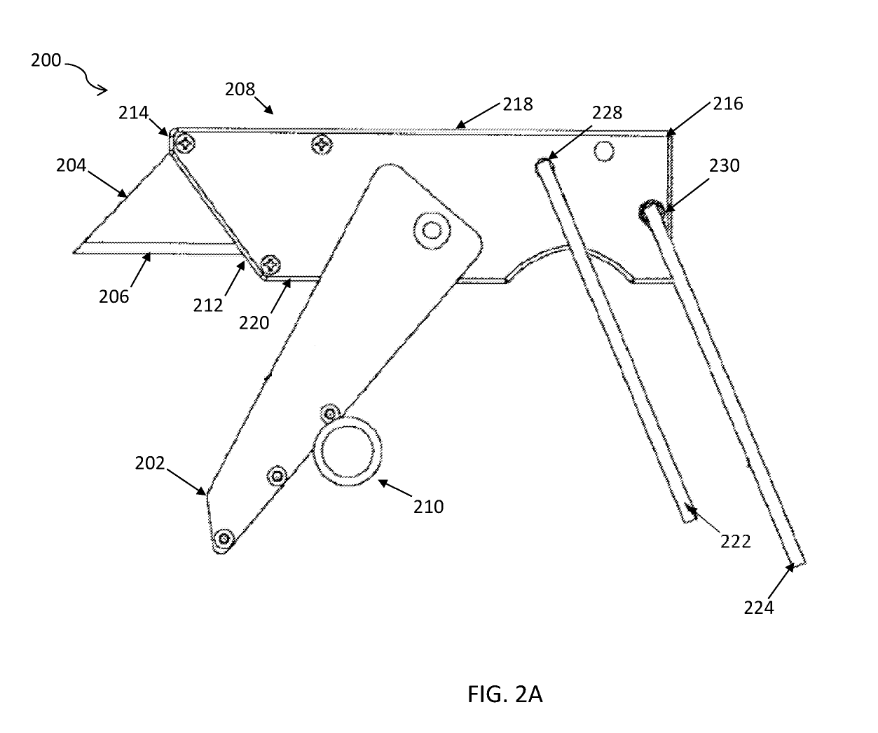

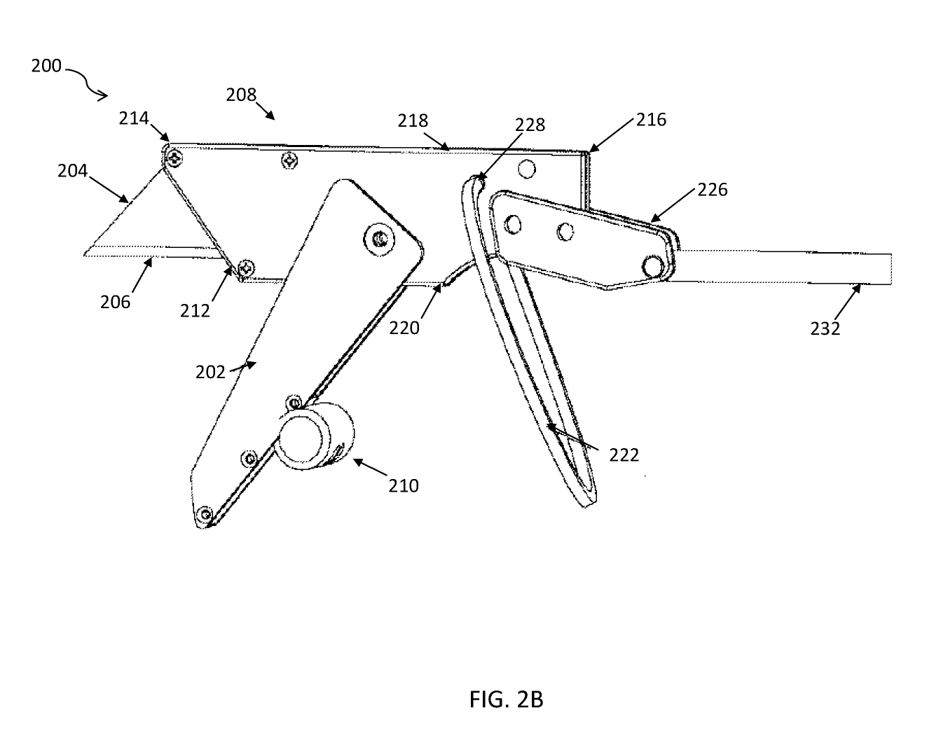

FIG. 2A is an illustration of another example utility apparatus 200, in accordance with embodiments of the disclosure. The utility apparatus 200 may include a moveable guard assembly 202, a blade 204, a housing 208, and a grip component 210. The housing 208 includes a longitudinal axis (lengthwise along the housing 208) and a lateral axis (perpendicular to the longitudinal axis). The housing 208 may include surfaces to allow a user to manipulate the utility apparatus 200. For instance, the housing 208 includes an upper surface 218 and a lower surface 220. As described in further detail below, the utility apparatus 200 may be worn on a user's hand. Thus, the lower surface 220, extending along the longitudinal axis of the housing 208, may be is configured to contact at least a portion of an upper surface of the user's hand.

The housing 208 may also include an opening 212 through which the blade 204 may extend. The blade 204 extends through the opening 212 in the housing 208 at a proximal end 214. The moveable guard assembly 202 may be configured to expose the at least one sharp edge 206 of the blade 204. In addition, the moveable guard assembly 202 may be configured to cover the at least one sharp edge 206 (e.g., as shown and discussed above with reference to FIG. 1B). As shown in FIG. 2A, the moveable guard assembly 202 is in an open configuration.

The grip component 210 of the utility apparatus 200 may be arranged with the moveable guard assembly 202 and configured to transition the moveable guard assembly 202 between a first (closed) configuration and a second (open) configuration. The grip component 210 may allow a user of the utility apparatus 200 to grip and manipulate the moveable guard assembly 202. In certain instances, the moveable guard assembly 202 may automatically transition from the open (second) configuration to the closed (first) configuration in the absence of a force applied by a user. The grip component 210 may be arranged with the moveable guard assembly 202 and configured to transition the moveable guard assembly 202 between the first configuration and the second configuration.

The utility apparatus 200 may also include an elastic strap 222 arranged near a distal end 216 of the housing 208. The elastic strap 222 may be configured to position and maintain the housing 208 along the upper surface of the user's hand. The user may position the hand through the elastic strap 222, which may engage the user's fingers. The elastic strap 222 may be biased to stretch when the user positions the hand through therethrough such that the elastic strap 222 elastically grips the user's fingers. In certain instances, the elastic strap 222 may be adjustable such that the user may tighten the elastic strap 222 to adjust the fit to the user's fingers.

Positioning of the utility apparatus 200 on a user's hand may allow the user to utilize the entire arm to apply torque to the utility apparatus 200. This may mitigate against long term injuries such as carpal tunnel syndrome. To employ the blade 204, the user may uses two fingers to straddle the grip component 210 and pull down on to expose the at least one sharp edge 206. In certain instances, the user may make a first while maintaining the wrist straight and perpendicular to the cutting surface, and pulls the blade 204 across the material being cut. This motion helps utilize more of the arm, shoulder, and back muscles to accomplish the cutting action thereby decreasing fatigue and strain on the users' wrist and hand.

The positioning of the utility apparatus 200 on the user's hand also allows for hand's free operation of another device. More specifically, the grip component 210 may be arranged with the moveable guard assembly 202 and configured to transition the moveable guard assembly 202 between the open and closed configurations. With the moveable guard assembly 202 closed over the sharp edge 206 of the blade 204, the user may be protected from accidental cutting of him or herself and of an object. Additionally, the user will have an empty hand (with the utility apparatus 200 positioned on top of the hand) to use other tools or for other purposes.

The utility apparatus 200 may also an additional elastic strap 224 that is positioned distally, relative to the housing 208, than the elastic strap 222. In certain instances, the additional elastic strap 224 may provide the user with additional leverage when using the blade 204. The additional elastic strap 224 may allow the user to further torque the utility apparatus 200 to and provide additional force to the blade 204. Similar to the elastic strap 222 being arranged through an aperture 228 in the housing 208, the additional elastic strap 224 may also be arranged through an aperture 230 in the housing 208.

In addition, the elastic strap 222 (and the additional elastic strap 224) may position and hold the utility apparatus 200 on the user's hand to avoid misplacing the utility apparatus 200, and mitigate against accidental dropping of the utility apparatus 200, which can lead to overhead fall/drop injuries. Further, the elastic strap 222 (and the additional elastic strap 224) positioning and holding the utility apparatus 200 on the user's hand also may allow for a user having injuries and amputations to use the utility apparatus 200. The utility apparatus 200 may not require a user to grip the entire of the housing 208.

FIG. 2B is an illustration of the example utility apparatus, shown in FIG. 2A, including a stabilizing rod 232, in accordance with embodiments of the disclosure. In certain instances, the distal end 216 of the housing 208 may include an extension portion 226, which arranges the stabilizing rod 232 relative to the housing 208. The stabilizing rod 232 may extend toward the elbow of the user along the upper portion of the forearm. The stabilizing rod 232 may be connected to the extension portion 226, which extends the stabilizing rod 232 further distally from the housing 208. In certain instances, the stabilizing rod 232 may provide the user with additional leverage when using the blade 204.

The utility apparatus 200 shown in FIGS. 2A-B is not intended to suggest any limitation as to the scope of use or functionality of embodiments of the subject matter disclosed throughout this disclosure. Neither should the utility apparatus 200 be interpreted as having any dependency or requirement related to any single component or combination of components illustrated in FIG. 1. For example, in embodiments, the utility apparatus 200 may include additional components. For example, the housing 208 may be formed by a first component 300 and a second component 400, as discussed in further detail below with reference respectively to FIGS. 3A-C and FIGS. 4A-B. Additionally, any one or more of the components depicted in FIGS. 2A-B can be, in embodiments, integrated with various ones of the other components depicted therein (and/or components not illustrated). For example, the elastic strap 222 may be integrated with the utility apparatus 100 shown and discussed with reference to FIGS. 1A-B. Any number of other components or combinations of components can be integrated with the illustrative utility apparatus 200 depicted in FIGS. 2A-B, all of which are considered to be within the ambit of this disclosure.

FIG. 3A is an isometric view illustration of a first component 300 that may be form a portion of an example utility apparatus housing, in accordance with embodiments of the disclosure. The first component 300 may form half of the housing of an example utility apparatus (e.g., as shown in FIGS. 1A, 1B, 2A, and 2B). The remaining half of the housing that interfaces with the first component 300 may have a similar exterior shape. In addition, the first component 300 may be secured to the remaining half of the housing by screws (or a similar structure), rivets, and/or an adhesive. In certain instances, the first component 300 may interface with a second component 400 (as discussed in further detail below with reference to FIGS. 4A-B). FIG. 3A shows an internal section of the first component 300 may form half of the housing of an example utility apparatus.

The internal section of the first component 300 includes a first surface 302 and a second surface 304. As shown in FIG. 3A, the second surface 304 may be recessed relative to the first surface 302. In addition, the second surface 304 may be shaped and sized to accommodate a utility blade. As a result, the second surface 304 may configured to hold a blade. The second surface 304 being recessed relative to the first surface 302 may provide a friction fit for a blade. In certain instances, the first component 300 may comprise blade locking cogs 310 arranged within second (recessed) surface 304. The blade locking cogs 310 may be configured to engage a blade and maintain the position of the blade within the housing during use. The blade locking cogs 310 may correspond to apertures in a utility knife blade, and may engage those apertures to hold the blade. As discussed in further detail below with reference to FIG. 4B, the first component 300 may interface with a second component to form the housing. The second component may have protruding portion that may serve to force the blade within the second surface 304.

The first component 300 may also include a magnet 308 (shown in FIG. 3C) that is arranged within the recessed second surface 304. The magnet 308 may engage a blade and maintain the position of the blade within the first component 300, and thus, within the housing during use.

FIG. 3B is a side view illustration of the first component 300, shown in FIG. 3A, in accordance with embodiments of the disclosure. An external section of the first component 300 is shown in FIG. 3B. The first component 300 may include a section 312 that houses a spring or similar biased structure. As noted above with reference to FIG. 1, the spring being configured to interface with a moveable guard assembly to automatically transition between a second configuration and a first configuration in the absence of a force applied by the user. The spring (or biased structure) being located within the section 312 of the first component 300 of the housing may force the moveable guard assembly toward the housing thereby covering a blade contained therein.

FIG. 3C is an end view illustration of the portion of the first component 300, shown in FIGS. 3A-B, in accordance with embodiments of the disclosure. The second surface 304 is shown recessed relative to the first surface 302. In addition, the blade locking cogs 310 may protrude outwardly relative to the second surface 304 without protruding past the first surface 302. In addition, the magnet 308 may be flush with (and nested within) the second surface 304.

FIG. 4A is an isometric view illustration of a second component that may be form a portion of an example utility apparatus housing, in accordance with embodiments of the disclosure. The second component 400 may form half of the housing of an example utility apparatus (e.g., as shown in FIGS. 1A, 1B, 2A, and 2B). In addition, the second component 400 may be secured to the remaining half of the housing by screws (or a similar structure), rivets, and/or an adhesive. In certain instances, the second component 400 may interface with the first component 300 (as discussed in further detail above with reference to FIGS. 3A-B).

An internal section of the second component 400 is shown in FIG. 4A. The second component 400 includes a third surface 402 and a fourth surface 404 (as compared to the first component 300), which may be arranged opposite that of the first surface 302 and the second surface 304 of the first component 300.

FIG. 4B is an end view illustration of the second component, shown in FIG. 4A, in accordance with embodiments of the disclosure. As shown in FIG. 4B, the fourth surface 404 protrudes outwardly from the third surface 402. In certain instances, the first component 300 and the second component 400 may be arranged to form a housing of a utility apparatus, constituent with various aspects of the present disclosure. When so arranged, the fourth surface 404 may be arranged toward the second (recessed) surface 304. As noted above, the second (recessed) surface 304 may be configured to hold a blade therein. In these such instances, the fourth surface 404 is configured to force the blade within the second (recessed) surface 304.

As noted above, the second (recessed) surface 304 may include a magnet 308 (shown in FIG. 3C) to hold a blade in place. Rather than disassembling the first component 300 and the second component 400 to install a blade, the protruding fourth surface 404 provides a path for a user to slide the blade thereon while temporarily avoiding the magnet 308. Once the blade is in position (e.g., the blade contacts a rear portion 406 of the fourth surface 404), the user may twist the blade from the protruding fourth surface 404 toward the second (recessed) surface 304, and the magnet 308 will engage the blade to hold the blade within the second (recessed) surface 304. To replace a blade, the user may twist the blade to disengage the blade from the magnet and the second (recessed) surface 304, and remove the blade therefrom.

A housing formed by the combination of the first component 300 and the second component 400 may be similar to the housing shown in FIGS. 1A-B or FIGS. 2A-B. As a result, the first component 300 and the second component 400 may form an opening (such as opening 112 shown in FIGS. 1A-b) in the housing through which the blade protrudes. Thus, installation and replacement of a blade may occur through the opening formed by the first component 300 and the second component 400

FIG. 5 is an isometric view illustration of a grip component portion 500 and a moveable guard assembly 502 that may be included with utility apparatuses, in accordance with embodiments of the disclosure. The grip component portion 500 and the moveable guard assembly 502 may be used in connection with the various example utility apparatuses discussed herein such as the utility apparatus shown in FIGS. 1A-B, FIGS. 2A-B, and/or the components discussed with reference to FIGS. 3A-C and FIGS. 4A-B.

As shown in FIG. 5, the grip component 500 includes a substantially cylindrical shape. In this manner, the grip component 500 may provide a surface for a user to grip and actuate the moveable guard assembly 502. In addition, the grip component 500 may include a width that is greater than a width of the moveable guard assembly 502, as is illustrated by the grip component 500 extending laterally beyond a side 504 of the moveable guard assembly 502. In certain instances, the grip component 500 may extend laterally beyond both sides 504, 506 of the moveable guard assembly 502. Further, the grip component 500 may be aligned with a lateral axis or width of the moveable guard assembly 502. In instances where the grip component portion 500 and the moveable guard assembly 502 are provided with a utility apparatus (e.g., the utility apparatus 100 shown in FIGS. 1A-B or the utility apparatus 200 shown in FIGS. 2A-B), the length or longitudinal axis of the moveable guard assembly 502 is aligned with the length or longitudinal axis of a housing of the utility apparatus. Because the grip component 500 is perpendicular to the moveable guard assembly 502, the grip component 500 will be aligned with the lateral axis of the housing (perpendicular to the length or longitudinal axis of the housing).

As discussed in further detail above, the moveable guard assembly 102 may be configured to cover and expose at least a sharp of a blade expose provided as part of a utility apparatus (e.g., the utility apparatus 100 shown in FIGS. 1A-B or the utility apparatus 200 shown in FIGS. 2A-B). The moveable guard assembly 502 may include an upper surface 508 that faces a housing of the utility apparatus. In addition, the moveable guard assembly 502 may include sidewalls 510, 512 that surround the upper surface 508. In the first (closed) configuration of the moveable guard assembly 502, a combination of the upper surface 508 and sidewalls 510, 512 are configured to cover a blade provided in the housing.

In addition and as noted above, the moveable guard assembly 502 may automatically transition from an open (second) configuration to a closed (first) configuration. This may be facilitated by use of a spring or other biased structure provided with the moveable guard assembly 502 and a portion of the housing (e.g., as shown and discussed with reference to FIG. 3B). The moveable guard assembly 502 may include a portion 514 that may interface and house the spring. Thus, the spring may arranged within the housing and be configured to interface with the moveable guard assembly 502 to automatically transition between the second (open) configuration and the first (closed) configuration in the absence of a force applied by the user.

The grip component portion 500 and the moveable guard assembly 502 shown in FIG. 5 is not intended to suggest any limitation as to the scope of use or functionality of embodiments of the subject matter disclosed throughout this disclosure. For example, in embodiments, the grip component portion 500 and the moveable guard assembly 502 may be integrated with the utility apparatuses shown and discussed with reference to FIGS. 1A-B, FIGS. 2A-B, and/or integrated with the components discussed with reference to FIGS. 3A-C and FIGS. 4A-B.

This application claims priority to Provisional Application No. 62/151,454, filed Apr. 23, 2015, which is herein incorporated by reference in its entirety. More specifically, FIGS. 9-14 of Provisional Application No. 62/151,454 shows an example utility apparatus tool worn by a user. FIGS. 9-14 are specifically incorporated by reference for the purposes of showing the arrangement of the example utility apparatus tool worn on the user's hand, wrist, and arm and operation thereof.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

The following is claimed:

1. An apparatus comprising:
a blade having at least one sharp edge;
a housing a distal end including an opening and a proximal end, the housing configured to releasably house the blade and position the blade through the opening;
a moveable guard assembly configured to cover the at least one sharp edge in a first configuration and expose the at least one sharp edge in a second configuration; and
a grip component arranged with the moveable guard assembly and configured to transition the moveable guard assembly between the first configuration and the second configuration.

2. The apparatus of claim 1, wherein the moveable guard assembly is configured to automatically transition between the second configuration and the first configuration in the absence of a force applied by a user.

3. The apparatus of claim 2, further comprising a spring arranged within the housing, the spring being configured to interface with the moveable guard assembly to automatically transition between the second configuration and the first configuration in the absence of a force applied by the user

4. The apparatus of claim 1, wherein the housing comprises a longitudinal axis and a lateral axis, and a lower surface of the housing extending along the longitudinal axis is configured to contact at least a portion of an upper surface of a user's hand.

5. The apparatus of claim 4, further comprising an elastic strap arranged near the distal end of the housing, the elastic strap being configured to position and maintain the housing along the upper surface of the user's hand.

6. The apparatus of claim 4, wherein the moveable guard assembly comprises a first width aligned with the lateral axis of the housing and the grip component comprises a second width aligned with the lateral axis of the housing, and the second width is greater than the first width.

7. The apparatus of claim 6, wherein the grip component comprises a substantially cylindrical shape.

8. The apparatus of claim 1, wherein the housing comprises an internal section and an external section, the internal section comprises first surface and a second surface, the second surface being recessed relative to the first surface and configured to hold the blade within the housing.

9. The apparatus of claim 8, further comprising blade locking cogs arranged within the recessed surface and configured to engage the blade and maintain the position of the blade within the housing during use.

10. The apparatus of claim 9, further comprising a magnet arranged within the recessed surface and configured to engage the blade and maintain the position of the blade within the housing during use.

11. The apparatus of claim 9, wherein the internal section comprises a third surface and a fourth surface, and the third surface and the fourth surface are arranged opposite the first surface and the second surface.

12. The apparatus of claim 11, wherein the fourth surface protrudes outwardly from the third surface toward the recessed surface, and the fourth surface is configured to force the blade within the recessed surface.

13. An apparatus for a user's hand, the apparatus comprising:
a blade having at least one sharp edge;
a housing including a proximal end, a distal end an opening arranged near the proximal end, and a lower surface configured to contact at least a portion of an upper surface of the user's hand, the housing being configured to releasably house the blade and position the blade through the opening;
a moveable guard assembly configured to cover the at least one sharp edge in a first configuration and expose the at least one sharp edge in a second configuration;
a grip component arranged with the moveable guard assembly and configured to transition the moveable guard assembly between the first configuration and the second configuration in response to the user applying a force; and
an elastic strap arranged near the distal end of the housing, the elastic strap being configured to position and maintain the housing along the upper surface of the user's hand.

14. The apparatus of claim 13, wherein the elastic strap is configured to wrap around the user's wrist to position and maintain the housing along the upper surface of the user's hand.

15. The apparatus of claim 13, wherein the moveable guard assembly is configured to automatically transition between the second configuration and the first configuration in the absence of the force applied by a user.

16. The apparatus of claim 13, wherein the moveable guard assembly comprises an upper surface facing the housing and sidewalls surrounding the upper surface, and the upper surface and the sidewalls of the moveable guard assembly are configured cover the blade in the first configuration.

17. A method of using a tool worn on a user's hand, the method comprising:
arranging a tool along an upper surface of the user's hand, the tool including a blade having at least one sharp edge, a housing including a proximal end, a distal end an opening arranged near the proximal end and being configured to releasably house the blade and position the blade through the opening, a moveable guard assembly configured to cover the at least one sharp edge, and a grip component arranged with the moveable guard assembly;
gripping a portion of the grip component; and
applying a force to the grip component to actuate the moveable guard in a first configuration away from the housing to expose the at least one sharp edge in a second configuration.

18. The method of claim 17, further comprising releasing the grip component to actuate the moveable guard from the second configuration to the first configuration.

19. The method of claim 18, wherein releasing the grip component includes covering the at least one sharp edge with the moveable guard assembly.

20. The method of claim 17, wherein arranging the tool along the upper surface of the user's hand comprising arranging an elastic strap, coupled to the housing, around the user's wrist to position and maintain the housing along the upper surface of the user's hand.
